(19) United States
(12) Patent Application Publication
(10) Pub. No.: US 2005/0165625 A1
(43) Pub. Date: Jul. 28, 2005

(54) Method and apparatus for providing a laboratory information management system for use in an e-commerce environment

(76) Inventors: Lance Anthony Ladic, Monmouth Junction, NJ (US); David Rapaport, Marlboro, NJ (US)

Correspondence Address: Siemens Corporation;Intellectual Property Department, 170 Wood Avenue South, Iselin, NJ, 08830, US

(21) Appl. No.: 11/042,128

(22) Filed: Jan. 24, 2005

Related U.S. Application Data
(60) Provisional application No. 60/538,668, filed on Jan. 23, 2004.

(51) Int. Cl. G06F 17/60

(52) U.S. Cl. 705/2

(57) ABSTRACT

An infrastructure for an ASP-LIMS (Application Service Provider-delivered Laboratory Information Management System) is disclosed. For example, the system may provide hardware infrastructure for the ASP (e.g., one or more servers, and network connectivity), libraries of related workflow modules, applications specific to processing laboratory and/or clinical data, embedded DSS (Decision Support System) software, and an optional data warehouse, e.g., for storing customer data in encrypted format for backup purposes. Finally, the present method and system provide an effective extension for use in an e-commerce environment.

### CROSS-REFERENCE TO RELATED APPLICATIONS

This application claims the benefit of U.S. Provisional Application No. 60/538,668 filed on Jan. 23, 2004, which is herein incorporated by reference.

### FIELD OF THE INVENTION

The present invention relates generally to a method and apparatus for storing and managing laboratory and/or clinical data (broadly defined as laboratory data). More specifically, the present invention discloses a method and system, e.g., a laboratory information management system (LIMS) for storing and managing laboratory workflows. Furthermore, the architecture is expanded to include e-commerce applications (e.g. data brokering) and bundling of products (data and/or physical items).

### BACKGROUND OF THE INVENTION

Laboratory workflows, in the case of a genomics laboratory, may comprise workflows associated with a gene chip experiment, a gel blot analysis, a gene expression analysis, an in-situ hybridization experiment, a microscopic imaging, a histological staining, and so on. Many institutions such as universities, clinical/industrial research laboratories, biotech companies, pharmaceutical companies and the like may generate various laboratory workflows that are very valuable. In fact, such institutions may themselves be consumers of such preexisting laboratory workflows that can be used to advance another research area. Unfortunately, there are many useful laboratory workflows—and the data that results from them—that are scattered across a large number of institutions, where these laboratory workflows and data are not readily searchable or even made available to the public. Thus, even if a customer is willing to pay an owner of a preexisting workflow to gain access to the laboratory work flow and associated data, it is not readily made known to the public.

Therefore, there is a need for a system and a method for storing and managing laboratory workflows, and for providing an e-commerce mechanism to facilitate access to, and purchasing of, data (and/or physical products) that result from these workflows.

### SUMMARY OF THE INVENTION

In one embodiment, the present invention discloses a method and system for storing and managing laboratory workflows in a laboratory information management system (LIMS). In one embodiment, although the present invention is described in the context of a LIMS related to genomics data, it could be extended to almost any form of laboratory/clinical data.

In one embodiment, the present invention provides the infrastructure for an ASP-LIMS (Application Service Provider-delivered Laboratory Information Management System). For example, the system may provide hardware infrastructure for the ASP (e.g., one or more servers, and network connectivity), libraries of related workflow modules, applications specific to processing laboratory data, embedded DSS (Decision Support System) software, and an optional data warehouse, e.g., for storing customer data in encrypted format for backup purposes. Finally, the present method and system provide an effective extension for use in an e-commerce environment.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a block diagram of an exemplary system of the present invention where a LIMS interacts with a plurality of customers;

FIG. 2 illustrates an exemplary example of a customized workflow and associated outputs, and the various applications that the LIMS may provide in accordance with the present invention;

FIG. 3 illustrates a block diagram of an exemplary system of the present invention where a LIMS is capable of providing a diagnostic solution;

FIG. 4 illustrates a method for storing and managing laboratory workflows and/or applications; and

FIG. 5 illustrates the present invention implemented using a general purpose computer.

### DETAILED DESCRIPTION

In one embodiment, the present invention provides the infrastructure for an ASP-LIMS (Application Service Provider-delivered Laboratory Information Management System). For example, the system may provide hardware infrastructure for the ASP (e.g., one or more servers, and network connectivity), libraries of related workflow modules, applications specific to processing laboratory data, embedded DSS (Decision Support System) software, and an optional data warehouse, e.g., for storing customer data in encrypted format for backup purposes and/or to facilitate e-commerce.

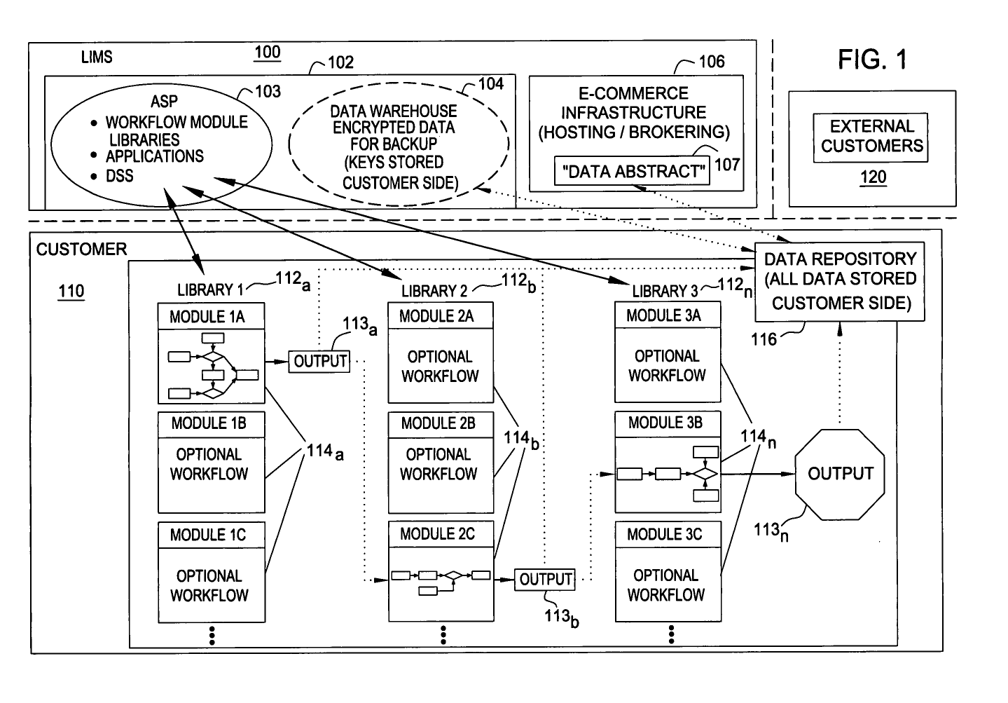

FIG. 1 illustrates a block diagram of an exemplary system of the present invention where a LIMS 100 interacts with a plurality of customers 110 and 120 (or customer platforms). In one embodiment, the LIMS comprises an application service provider module 103, a data warehouse module 104, and an e-commerce module 106. Although FIG. 1 illustrates the modules 103, 104, and 106 as being implemented within a single system, the present invention is not so limited. For example, the application service provider (ASP) module 103, the data warehouse module 104, and the e-commerce module 106 can be implemented as individual systems if necessary.

In one embodiment, the LIMS 100 constructs libraries of “workflow modules” where each “module” corresponds to a particular laboratory workflow (e.g., in the case of a genomics laboratory, some workflows could be: gene chip experiment, gel blot analysis, gene expression analysis, in-situ hybridization experiment, microscopic imaging, histological staining, etc.). However, it should be noted that although the present invention is described in the context of a LIMS related to genomics data, the present invention is intended to be extended to almost any form of laboratory/clinical data.

The individual workflows can be gathered from customers 110 and 120 (e.g. such as university laboratories, clinical research laboratories, biotech companies, pharmaceutical companies and the like) and assembled into libraries of related workflows. Although these workflows would be considered as “best practice” workflows and form the basis of the module libraries, they could be further enhanced, e.g., by applying Six Sigma analysis before being included.

In one embodiment, the workflows can be gathered or submitted by customers for a fee. For example, a customer may have developed a new workflow (or a new library of workflows) for gene expression analysis and is willing to share this new workflow to others for a fee. In doing so, the LIMS will receive the new workflow and will store the workflow in the ASP 103. A prescribed fee can be assessed whenever the new workflow is downloaded from the ASP by another customer, where the submitter of the new workflow will receive a portion of that fee. Other revenue models can be employed, e.g., subscription model for use of the ASP, charge per number of modules used, charge per applications used, and charge for data warehousing as described below.

In one embodiment, based on the configuration of their laboratory and type of work being performed, a customer can select desired modules from these pre-defined libraries of workflows (either using a “wizard” user interface that guides them through the selection process using DSS, or by browsing the various libraries and picking out modules that most closely fit their clinical/experimental workflow) and create their own customized workflow as discussed below. Decision Support Systems (DSS) are a class of computerized information system that support decision-making activities. DSS are interactive computer-based systems and subsystems that are designed to help decision makers use communications technologies, data, documents, knowledge and/or models to complete decision process tasks.

FIG. 1 illustrates an example where a customer 110 has downloaded a plurality of libraries 112a-112n workflows 114a-114n. Individually selected modules can then be connected to create an overall workflow by the customer. In one embodiment, the process of choosing modules can be implemented using visual/WYSIWYG (what-you-see-is-what-you-get), drag and drop, and the like. Each individual pre-defined library module can be modified to better accommodate the customer's needs using a standard set of object-oriented, database-related tools (e.g. fields can be added to capture data from a workflow step, data labels can be modified, workflow steps can be added, etc.) Thus, the option of constructing a completely customized workflow module from scratch using the above-described tools is also available. All of the configuration and customization of the modules can be stored on the customer's side, e.g., in data repository 116. It should be noted that the outputs 113a-113b from each of the workflow modules and the final output for the entire customized workflow 113n can also be stored in the data repository 116.

In one embodiment, custom applications can be embedded in some of the workflow modules, and can be inserted into customized modules in an object-oriented fashion when editing/constructing a workflow in the WYSIWIG environment. Such applications may include image analysis for gene/protein chip experiments, gene/protein sequence analysis/pattern matching, image analysis for gel blots, image analysis for optical imaging experiments, image analysis for molecular imaging experiments, and so on.

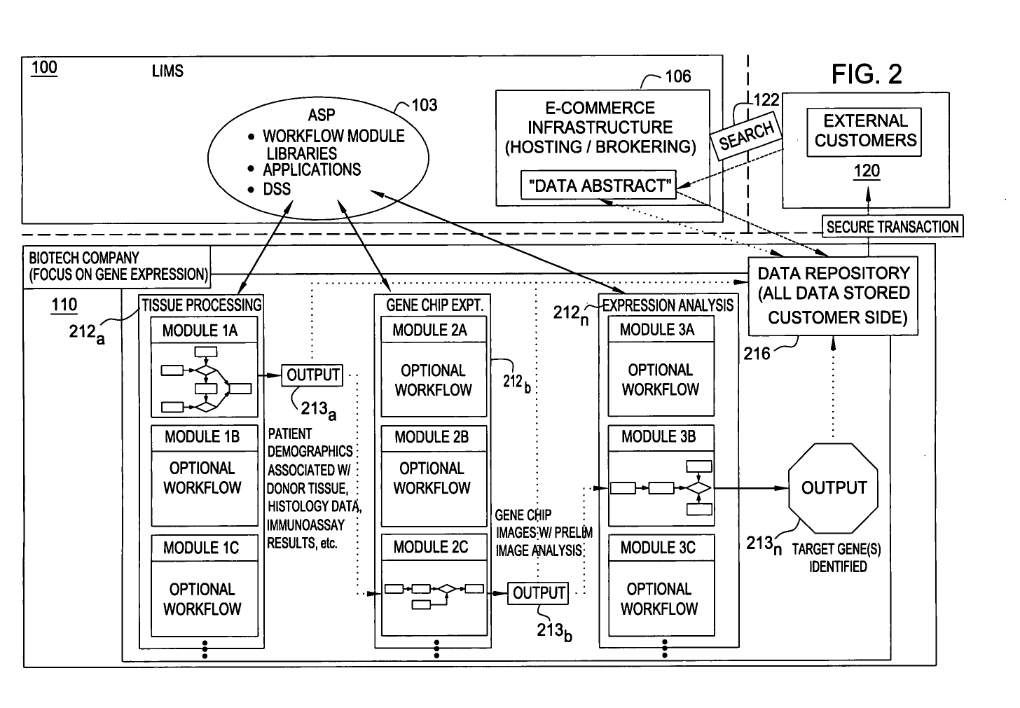

FIG. 2 illustrates an exemplary example of a customized workflow and associated outputs, and the various applications that the LIMS 100 may provide for data analysis in the context of a genomics experiment in accordance with the present invention. FIG. 2 illustrates a customer 110 that is a biotech company that is focusing on gene expression. In turn, the customer has acquired a library 212a of workflows on tissue processing, a library 212b of workflows on gene chip experiment and a library 212n of workflows on expression analysis. These libraries can be downloaded from the LIMS 100. The customer 110 can craft a customized overall workflow by selecting the pertinent workflows from each of the libraries. In turn, the data or output from each of the workflow modules can be stored in the data repository 216.

In one embodiment, all of the data (including all of the data outputs from individual workflow module or steps from within each of the modules, as well as the final, overall workflow output) can be stored in the repository 216. Since all the data represents important intellectual property and may be the main source of revenue for the customer 110, many customers are unwilling to allow their data to be stored by an outside party. In light of this, all processing of data can be performed on the client or customer side, with only instructions being sent back to the ASP 103, e.g., to identify the next module/workflow step that is needed, to request an application (e.g., a gene chip image analysis application, a pattern matching application, a sequence searching/analysis application and so on) or DSS logic, etc.

In one embodiment, all data (including the output from intermediate steps) can be stored with “intelligent tagging” (e.g., meta-tagging, XML tags) such that it can be easily identified. This tagging would not only facilitate searching for data by the customer, but could also be used with an e-commerce model (e.g., via e-commerce module 106) to allow external customers 120 to locate data items of interest via a search request 122. In addition to providing a detailed description of the data, it could also be used to denote the financial value of the data for e-commerce.

In one embodiment, the present invention provides the ability to store the customer data in a data warehouse (e.g., 104 of FIG. 1) in an encrypted format for backup purposes and/or for the potential of e-commerce. Since strong encryption would be used, the customer does not have to worry about the privacy of their data being compromised. In this scenario, it would be the customer's responsibility to safely store encryption/decryption keys (e.g., public keys, private keys, and the like) for unlocking the data. In the event of a problem on the client side where data is lost, a copy of the data can be retrieved from the data warehouse and restored using encryption/decryption keys that the client possesses. The encrypted data in the data warehouse could also be used in the e-commerce implementation as described below.

FIGS. 1-2 illustrate a LIMS that is capable of supporting e-commerce hosting and/or or brokering of LIMS-generated data. In one embodiment, the present invention allows customers, e.g., via software application, to generate “abstracts” of their data that can be supplied to LIMS to be stored on the e-commerce module or server(s) 106. For example, the software application would permit “intelligent tagging” of the data (as described above) that would not only provide detailed information about the data but also an associated financial value. Additionally, the software application on the customer side would allow transmission of a continuously-updated “data abstract” from the customer's data repository to the e-commerce server hosted by the LIMS as well as facilitate a secure transmission of data between customers 110 and an external party or another customer 120 in the event of a financial transaction. The software application would also allow consolidation of the “data abstracts” from multiple customers into a “master abstract” and the ability to associate an individual data item with an individual customer.

To illustrate, the LIMS may host a web site that is accessible by a plurality of customers. Thus, an external party or customer 120 can search a continuously-updated “data abstract” 107 on the e-commerce server or module 106. The “data abstract” 107 provides the external party 120 with a “teaser view” of the actual data rather than the actual data itself (which is stored on the customer's side 110). The “data abstract” could be from a single customer or (preferably) represents a “master data abstract” that has a consolidated version of all of the “data abstracts” from a multiple of customers 110. If the external party 120 locates a piece of data that they wish to purchase, the LIMS 100 facilitates a secure transmission between the external party 120 and the appropriate customer 110 where the actual data resides. In this way, the LIMS 100 serves as the “information broker” between customers 110 and external parties 120 who may wish to purchase information from customers 110.

In the event that the data refers to an actual (physical) object that the customer 110 is offering for sale (e.g., a custom-designed gene/protein chip, a purified gene/protein sample, a contrast agent, etc.), and a transaction request is made, the LIMS 100 will facilitate the order request on behalf of the external party 120 to the customer 110 (e.g., provide the billing/shipping information to the customer 110). Thus, the present invention is not limited to e-commence of electronic products that can be electronically transferred to the customers in a secured transmission medium, but in fact, it also encompasses the sending of physical products to the customers. Again, the operator of the LIMS 100 may actually carry such physical products to be shipped directly to the customers, or it may simply facilitate the ordering of such physical products from the proper manufacturers.

In an alternate embodiment, data from the customer 110 (e.g. a biotech company, “the seller”) could be stored in an encrypted format in a data warehouse 104 that is hosted by the LIMS (“the broker”). In this scenario, an external party 120 (e.g. a pharmaceutical company, “the buyer”) would search the data abstract(s) 107 stored on the e-commerce server or module 106. If an item of interest is found and a financial transaction is requested, the desired data is retrieved (in an encrypted format) from the data warehouse 104 and sent to the buyer 120. A notification would be sent to the seller 110 requesting that a decryption key(s) specific to the data being purchased be sent to the buyer 120. The buyer 120 could then unlock the data on their side into an unencrypted readable/usable form. Since the seller 110 only sends key(s) to unlock the data (which could be embedded into a short email) this reduces the amount of bandwidth used on the seller's end.

It should be noted that the “data abstract” provided by each customer 110 includes not only the “final” data output of their overall workflow, but it may also contain data generated at intermediate workflow steps, as these could also possess value. Examples of “outputs” of genomics-related data (non-physical) that may possess financial value may include but are not limited to:
generalized demographics data statistics, associated with other data objects,
gene expression data,
gene sequence data,
x-ray crystallography/protein structure data,
imaging data (many types: from imaging modalities, molecular imaging, optical imaging, microscopy data, etc.), and
gel analysis data.

In one embodiment, the data would have to be stripped of all personal identifiers and remain generic, in accordance with any legal requirements (e.g. HIPAA).

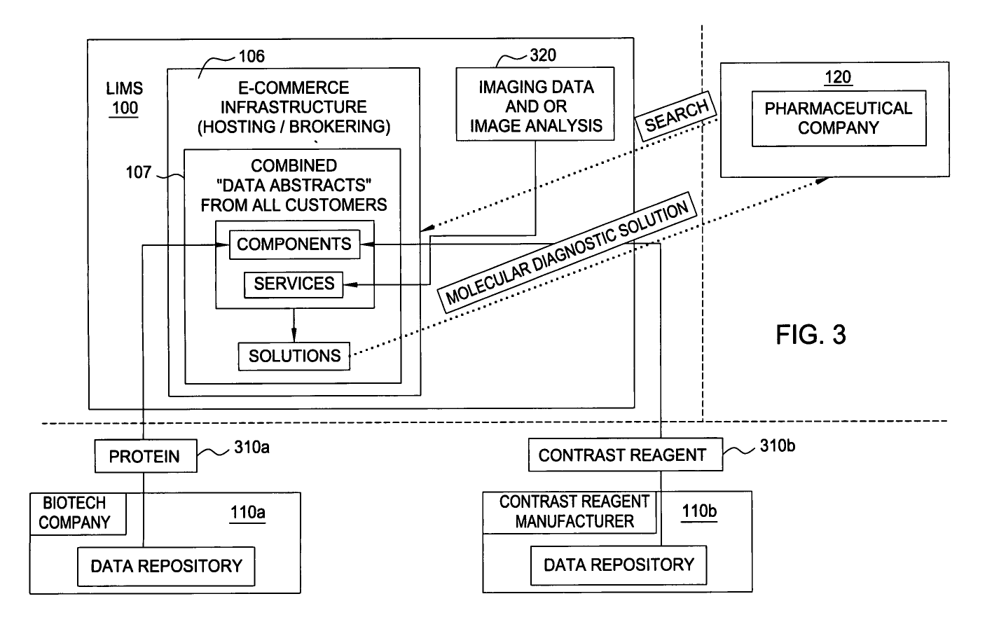

FIG. 3 illustrates a block diagram of an exemplary system 300 of the present invention where a LIMS is capable of providing a diagnostic solution. In this scenario, the LIMS operator may partner with external companies to provide a “bundled solution” for molecular diagnostics and/or clinical evaluation to a “buyer”.

To illustrate, in the specific example presented in FIG. 3, a first customer 110a is a biotech company that provides a protein 31oa (that is associated with a disease state, i.e., a potential target for drug discovery) and a second customer 110b is a contrast agent manufacturer that provides a contrast reagent 310b that is specific to visualizing the protein (or some component associated with the protein or disease state). These “components” (the protein and the contrast reagent) are listed in the master data abstract 107 on the e-Commerce server 106. The LIMS would offer a service to provide the imaging data and/or image analysis 320 that could be bundled with each of these other components to form a “solution” that could be purchased by a pharmaceutical company 120. The pharmaceutical company could use the protein as the basis for developing a drug, and then use the specific contrast reagent in combination with imaging/image analysis in the clinical testing/evaluation of drug efficacy. Although the pharmaceutical company could purchase each component or service individually, the overall value is enhanced through the bundling of various components into a complete “solution”. Thus, the customer 120 may simply submit a general request for a solution and the LIMS 100 will assemble the necessary components that it determines to be sufficient to meet the requirement of the request. Before sending the bundled components to the customer, LIMS 100 may present the list of bundled components to allow the customer to review, modify and/or approve the list before the bundled components are downloaded.

In the above example, medical imaging and associated image analysis can also be deemed as valuable components that can be assembled and offered to customers. This novel approach allows medical imaging manufacturers to also leverage their experience with medical imaging and associated image analysis to interested customers who may benefit from the most updated image analysis techniques.

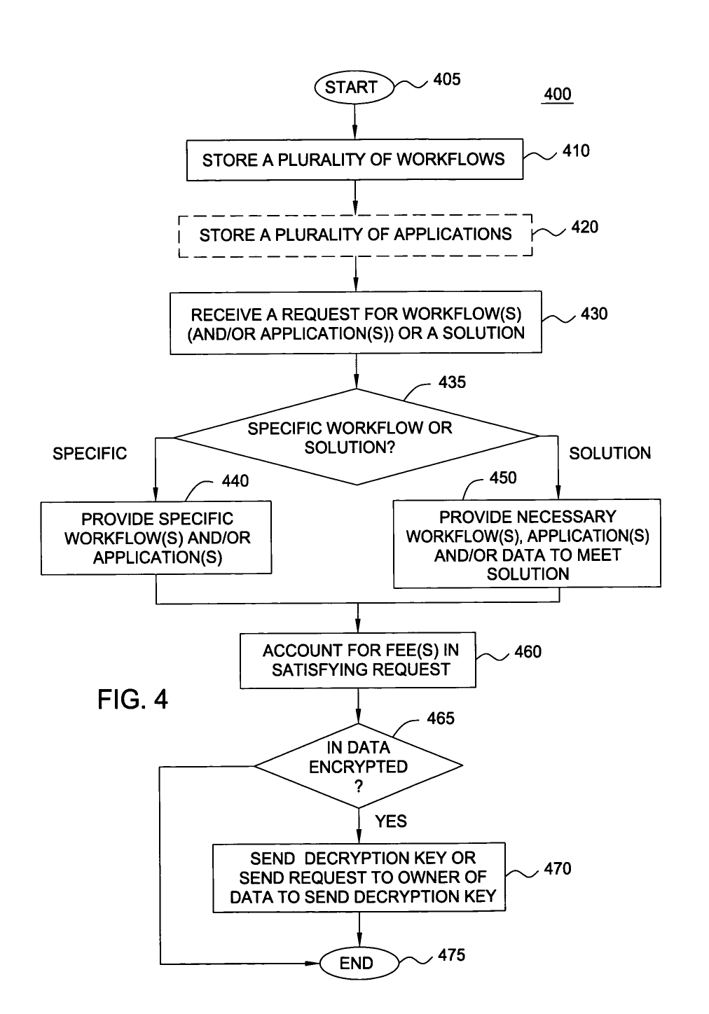

FIG. 4 illustrates a method 400 for storing and managing laboratory workflows and/or applications. Method 400 starts in step 405 and proceeds to step 410.

In step 410, method 400 stores a plurality of workflows. These workflows can be collected internally and/or collected from customers as discussed above.

In step 420, method 400 may optionally store a plurality of custom applications such as gene chip image analysis applications, pattern matching applications, sequence searching/analysis applications and the like. These applications can be collected internally and/or collected from customers. Namely, similar to workflows, customers may have the ability to develop a particular application for use with particular laboratory/clinical data, e.g., an application for image analysis to be used with a particular contrast agent. This step will allow customers to submit custom applications for use by other customers, thereby generating a revenue stream.

In step 430, method 400 receives a request for one or more workflows and/or custom applications and associated data. Alternatively, method 400 may receive a request for a solution, requiring a bundling of components (e.g., a general request for the necessary components to perform image analysis for detecting a particular protein using a particular contrast agent).

In step 435, method 400 determines whether the request is for specific workflow(s) (and/or custom application(s)) or whether the request is for a general solution. If the request is a specific request, method 400 proceeds to step 440. If the request is for a general solution, method 400 proceeds to step 450.

In step 440, the specified workflow(s), application(s) and/or data are provided to the requesting party. For example, the requested workflow(s), application(s) and/or data can be electronically sent to the customer via a secure transaction mechanism, e.g., encryption, encoding and the like via a network (e.g., the Internet and the like).

In step 450, method 400 processes the request to determine what components are available to meet the solution as requested. These components (e.g., workflow(s), analysis application(s) and/or data) are collected and presented to the customer. If the customer finds that the collected components will meet the solution, these components can be electronically sent to the customer via a secure transaction mechanism, e.g., encryption, encoding and the like.

In step 460, method 400 performs accounting of fees in servicing the request. For example, fees must be collected in satisfying the request. Additionally, if applicable, accounting must be updated to reflect a royalty fee that must be accounted to compensate the submitter who provided the workflow(s), data, and/or applications that were downloaded to the requesting client.

In step 465, method 400 queries whether the requested data was protected, e.g., via encryption or other similar techniques. If the query is positively answered, method 400 proceeds to step 470. If the query is negatively answered, then method 400 ends in step 475.

In step 470, method 400 may send the necessary key(s), e.g., a decryption key(s) to the requesting customer, so that the requesting customer can gain access to the protected data. Alternatively, if the necessary key(s), e.g., a decryption key(s) are stored locally by the submitter or owner of the workflow(s), data and/or application(s), then method 400 will simply forward a request to the owner of the workflow(s), data and/or application(s) to forward the necessary key(s), e.g., a decryption key(s) directly to the requesting customer. Method 400 ends in step 475.

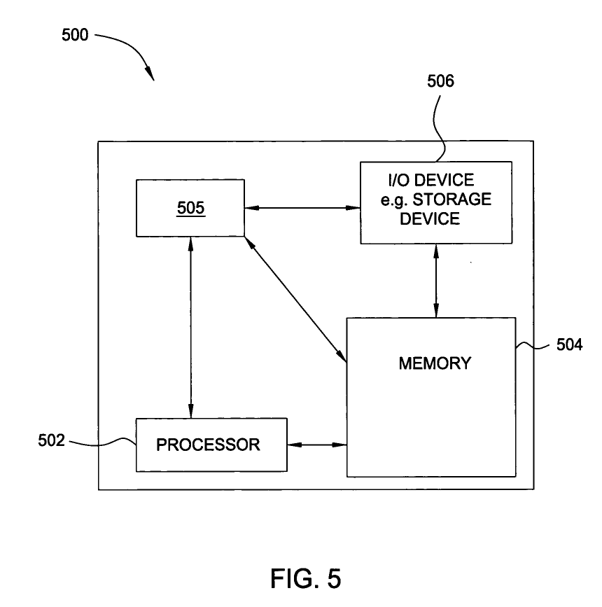

FIG. 5 is a block diagram of the present invention being implemented with a general purpose computer. In one embodiment, the LIMS 500 (or any portion thereof) is implemented using a general purpose computer or any other hardware equivalents. In fact, each of the customer platforms can be perceived as having a general structure that is similar to that shown in FIG. 5. More specifically, the LIMS 500 comprises a processor (CPU) 502, a memory 504, e.g., random access memory (RAM) and/or read only memory (ROM), one or more modules 505 (e.g., ASP, data warehouse module, e-commerce module and the like) as described above, and various input/output devices 506 (e.g., storage devices, including but not limited to, a tape drive, a floppy drive, a hard disk drive or a compact disk drive, a receiver, a decoder, a decryptor, a transmitter, a clock, a speaker, a display, an output port, a user input device (such as a keyboard, a keypad, a mouse, and the like), or a microphone for capturing speech commands).

It should be understood that the one or more components or elements 505 can be implemented as a physical device or subsystem that is coupled to the CPU 502 through a communication channel. Alternatively, the one or more components or elements 505 can be represented by one or more software applications (or even a combination of software and hardware, e.g., using application specific integrated circuits (ASIC)), where the software is loaded from a storage medium (e.g., a magnetic or optical drive or diskette) and operated by the CPU in the memory 504 of the computer. As such, the one or more components or elements 505 (including associated data structures and methods) of the present invention can be stored on a computer readable medium or carrier, e.g., RAM memory, magnetic or optical drive or diskette and the like.

While the foregoing is directed to embodiments of the present invention, other and further embodiments of the invention may be devised without departing from the basic scope thereof, and the scope thereof is determined by the claims that follow.

1. A method for managing workflows relating to laboratory data, the method comprising:
storing a plurality of workflows;
receiving a request from a customer for at least one of said plurality of workflows; and
sending said at least one of said plurality of workflows via a network to said customer in accordance with a revenue model.

2. The method of claim 1, wherein said plurality of workflows comprises at least one of: gene chip experiment, gel blot analysis, gene expression analysis, in-situ hybridization experiment, microscopic imaging, and histological staining.

3. The method of claim 1, further comprising:
storing a plurality of applications relating to laboratory data.

4. The method of claim 3, wherein said request further includes a request for at least one of said plurality of applications.

5. The method of claim 4, wherein said plurality of applications comprises at least one of: an image analysis for gene/protein chip experiments application, a gene/protein sequence analysis/pattern matching application, an image analysis for gel blots application, an image analysis for optical imaging experiments application, and an image analysis for molecular imaging experiments application.

6. The method of claim 3, wherein said request is a request for a solution, wherein said sending step will send at least one of: one of said plurality of workflows, one of said plurality of applications, data, and a physical product.

7. The method of claim 3, wherein said revenue model comprises at least one of: a subscription model, a per charge model for each of said workflows, and a per charge model for each of said applications.

8. The method of claim 1, wherein said at least one of said plurality of workflows is sent in a protected format.

9. The method of claim 8, where at least one key is sent to the customer to gain access to said at least one of said plurality of workflows.

10. The method of claim 9, wherein said at least one key is sent directly to said customer from an owner of said at least one of said plurality of workflows.

11. The method of claim 3, further comprising:
allowing said customer to search a database containing said workflows and said applications.

12. A computer-readable medium having stored thereon a plurality of instructions, the plurality of instructions including instructions which, when executed by a processor, cause the processor to perform the steps of a method for managing workflows relating to laboratory data, comprising of:
storing a plurality of workflows;
receiving a request from a customer for at least one of said plurality of workflows; and
sending said at least one of said plurality of workflows via a network to said customer in accordance with a revenue model.

13. The computer-readable medium of claim 12, wherein said plurality of workflows comprises at least one of: gene chip experiment, gel blot analysis, gene expression analysis, in-situ hybridization experiment, microscopic imaging, and histological staining.

14. The computer-readable medium of claim 12, further comprising:
storing a plurality of applications relating to laboratory data.

15. The computer-readable medium of claim 14, wherein said request further includes a request for at least one of said plurality of applications.

16. The computer-readable medium of claim 15, wherein said plurality of applications comprises at least one of: an image analysis for gene/protein chip experiments application, a gene/protein sequence analysis/pattern matching application, an image analysis for gel blots application, an image analysis for optical imaging experiments application, and an image analysis for molecular imaging experiments application.

17. The computer-readable medium of claim 14, wherein said request is a request for a solution, wherein said sending step will send at least one of: one of said plurality of workflows, one of said plurality of applications, data, and a physical product.

18. The computer-readable medium of claim 14, wherein said revenue model comprises at least one of: a subscription model, a per charge model for each of said workflows, and a per charge model for each of said applications.

19. The computer-readable medium of claim 12, wherein said at least one of said plurality of workflows is sent in a protected format.

20. The computer-readable medium of claim 19, where at least one key is sent to the customer to gain access to said at least one of said plurality of workflows.

21. The computer-readable medium of claim 20, wherein said at least one key is sent directly to said customer from an owner of said at least one of said plurality of workflows.

22. The computer-readable medium of claim 14, further comprising:
allowing said customer to search a database containing said workflows and said applications.

23. An apparatus for managing workflows relating to laboratory data, comprising:
means for storing a plurality of workflows;
means for receiving a request from a customer for at least one of said plurality of workflows; and
means for sending said at least one of said plurality of workflows via a network to said customer in accordance with a revenue model.

24. The apparatus of claim 23, wherein said plurality of workflows comprises at least one of: gene chip experiment, gel blot analysis, gene expression analysis, in-situ hybridization experiment, microscopic imaging, and histological staining.

25. The apparatus of claim 23, further comprising:
storing a plurality of applications relating to laboratory data.

26. The apparatus of claim 25, wherein said request further includes a request for at least one of said plurality of applications.

27. The apparatus of claim 26, wherein said plurality of applications comprises at least one of: an image analysis for gene/protein chip experiments application, a gene/protein sequence analysis/pattern matching application, an image analysis for gel blots application, an image analysis for optical imaging experiments application, and an image analysis for molecular imaging experiments application.

28. The apparatus of claim 25, wherein said request is a request for a solution, wherein said sending step will send at least one of: one of said plurality of workflows, one of said plurality of applications, data, and a physical product.

29. The apparatus of claim 25, wherein said revenue model comprises at least one of: a subscription model, a per charge model for each of said workflows, and a per charge model for each of said applications.

30. The apparatus of claim 23, wherein said at least one of said plurality of workflows is sent in a protected format.

31. The apparatus of claim 30, where at least one key is sent to the customer to gain access to said at least one of said plurality of workflows.

32. The apparatus of claim 31, wherein said at least one key is sent directly to said customer from an owner of said at least one of said plurality of workflows.

33. The apparatus of claim 25, further comprising:
allowing said customer to search a database containing said workflows and said applications.
